(19) United States
(12) Patent Application Publication
(10) Pub. No.: US 2013/0149145 A1
(43) Pub. Date: Jun. 13, 2013

(54) WIND TURBINE

(71) Applicants: Masaaki Shibata, Minato-ku (JP); Hidekazu Ichinose, Minato-ku (JP); Jens Alwart, Berlin (DE); Andreas Cremer, London (GB)

(72) Inventors: Masaaki Shibata, Minato-ku (JP); Hidekazu Ichinose, Minato-ku (JP); Jens Alwart, Berlin (DE); Andreas Cremer, London (GB)

(73) Assignees: Euros Entwicklungsgesellschaft Fur Windkraftanlagen MBH, Berlin (DE); MITSUBISHI HEAVY INDUSTRIES, LTD., Minato-ku, Tokyo, (JP)

(21) Appl. No.: 13/389,931

(22) PCT Filed: Dec. 9, 2011
(86) PCT No.: PCT/JP2011/006905

§ 371 Date: Jun. 18, 2012

(51) Int. Cl. F03D 11/00

(52) U.S. Cl. 416/1; 416/61

(57) ABSTRACT

The invention relates to a wind turbine, comprising a tower, a nacelle, at least one blade with a tip end and a root end and monitoring means for monitoring the surface condition of the blade, wherein said monitoring means are located at the tower or at the nacelle and wherein said monitoring means are adapted to monitor the surface condition of at least substantially one entire side of the blade from its tip end to its root end.

### TECHNICAL FIELD

The invention relates to a wind turbine comprising monitoring means, a condition monitoring system and a method for monitoring the surface condition of a wind turbine blade.

### BACKGROUND ART

Monitoring the surface condition of wind turbine blades, with wind turbine blades being one of the most highly stressed components of wind turbines, has become even more significant since the trend in wind turbine development in recent years has evolved towards an increased size of wind turbine components. Due to this development, the components of wind turbines are designed closer to the material limit and therefore more prone to a reduction of fatigue strength and material damages due to the high amount of stress and strain acting on them. Noticing material damage as soon as possible is extremely crucial to avoid further damages since intervention in the early stages of deterioration is usually much more cost effective than allowing the component to fail completely. Usually, monitoring systems allowing a remote control compared to sending staff to the wind turbine are the most efficient and for off-shore wind turbines also the only way for monitoring the surface condition of the blades.

Monitoring means known in the prior art for monitoring the surface condition of wind turbine blades are usually positioned on the nacelle. US 2010/0135788 A1 discloses such monitoring means in form of video cameras which are mounted on the nacelle or at ground level. However, such monitoring means are only able to monitor the blade surface condition in a very restricted area of the blade. Even though monitoring means mounted on the nacelle will be able to monitor surface damages of the root portion of the blade, they will not be able to monitor the surface condition of e.g. the tip portion of the blade.

### SUMMARY OF INVENTION

It is the object of the invention to provide a wind turbine in such a way that an enhanced monitoring of the wind turbine blades is achieved. A further object of the present invention is to provide an improved condition monitoring system adapted to process the monitoring data of the monitoring means. An even further object of the invention is to provide a method for monitoring the blade surface condition of a wind turbine.

According to the present invention, the wind turbine comprises a tower, a nacelle and at least one blade with a tip end and a root end. Preferably, the wind turbine comprises a plurality of blades. The blades of the wind turbine are mounted on a hub which is coupled to the nacelle. The nacelle is arranged atop of the tower and rotatable around the longitudinal axis of the tower so that the blades can be positioned with respect to the direction of the wind.

In accordance with the present invention, the wind turbine further comprises monitoring means which are located at the tower or the nacelle, in particular at the outside of the tower or the nacelle. Preferably, the monitoring means are arranged at a distance from the blade. The monitoring means are preferably permanently installed at the wind turbine and are especially suited to be used for monitoring the blade surface condition at any time, including during operation of the wind turbine. The monitoring means are not installed only and specifically for maintenance but they are installed and adapted to monitor the blade surface condition outside of the usual maintenance times of the wind turbine, i.e. during its operation.

The monitoring means are adapted to monitor the surface condition of at least substantially one entire side of the blade from its tip end to its root end. In this way, the surface condition of one side of the blade along substantially its complete length can be monitored. The term “side of the blade” can be understood as the leading edge, the trailing edge, the suction side or the pressure side of the blade. Particularly, at least 80 percent, preferably 90 percent, of the surface condition of one entire blade side can be monitored. In a particularly preferred embodiment, the surface condition of the entire length of at least one side of the blade can be monitored from its tip end to its root end.

The term “surface condition of the blade” relates to any damages of the surface. These could be damages due to lightning, hail or any other environmental condition as well as corrosion damage, coating damage or structural damage, such as cracks or holes. In addition to damages, “surface condition” could also be any other environmental condition, such as e.g. the icing condition of the blade.

By the term “monitoring” observation from a distance is meant which can include recording monitoring data and sending it to a processing system. In this way, the monitoring means enable a user to inspect the surface condition of the blade remotely without the need to evaluate the surface in person which would be time consuming and ineffective.

In particular, monitoring means can comprise optical recording means, such as photo or video cameras. In the case of cameras, the monitoring of the surface condition is done optically by taking images or videos of the blade surface. Preferably, the monitoring means comprises illumination means, such as e.g. a flashlight, for the illumination of the blade surface which are in particular arranged together with the optical recording means in such a way that a better quality of the optical monitoring data can be achieved. The monitoring data in the form of videos or images can be sent to a system for processing the data, preferably a condition monitoring system. The monitoring means can preferably also be adapted to process the data before sending it to a condition monitoring system.

In a further embodiment, the optical recording means comprise at least one wide-angle lens to monitor a greater range of optical information. Preferably, the optical recording means are shielded from rain by a water-proof housing. In a further embodiment, the optical recording means comprise cleaning means, such as e.g. a wiper mechanism, in order to remove any kind of dirt, dust, salts or crystals from the monitoring means.

Monitoring means can also comprise at least one means for transmitting and receiving acoustic waves, such as an acoustic sensor, preferably for ultrasound. The acoustic sensor comprises a transmitter and a sender. By using an acoustic sensor for ultrasound, monitoring the surface condition is done by emitting ultrasound onto the blade surface, therefore exciting oscillations in the blade material for a certain period of time and measuring the return acoustic sound waves. In this case, monitoring data would comprise the received acoustic waves or information about them. In general, it is preferable that any settings of the monitoring means can be controlled remotely. Monitoring means can also refer to any other evaluation means, such as e.g. microphones, shearography testing means, thermography testing means, x-ray testing means, infrared or any other kind of sensors.

In a further embodiment of the invention, the monitoring means comprise at least one camera and/or at least one acoustic sensor. The monitoring means can also comprise a plurality of cameras or acoustic sensors.

In a further embodiment of the invention, a plurality of monitoring means is arranged at the tower or the nacelle. Preferably, the monitoring means are arranged in such a way that at least substantially one entire side of the blade in longitudinal direction, but preferably the entire blade side, is covered for monitoring when the blade is aligned along the longitudinal direction of the tower. This could for example be achieved by arranging monitoring means at various positions along the length of the tower or around the tower. Preferably, the monitoring means are arranged in a swivel-mounted or rotatable way so that each monitoring means covers a larger part of the blade surface for monitoring.

Monitoring is usually carried out at times with low wind forces. Then the rotation of the blades is stopped and the blade to be monitored is preferably aligned parallel to the longitudinal axis of the tower. Therefore, preferably one certain rotational position of the nacelle and hence the blade is set as a monitoring position of the blade for monitoring their surface condition. In this case, the monitoring means can be arranged along the tower facing the blade when the nacelle and the blades are in the monitoring position. Alternatively, the monitoring can be carried out while the blades are still moving, preferably slowly moving, by e.g. taking photographs or videos of the blade surface.

In a further alternative embodiment, the monitoring means can be arranged around the tower in such a way that some monitoring means face the blade at any rotational position of the nacelle and monitoring can be carried out. In this case, no extra rotation of the nacelle in order to move the blades into a certain monitoring position has to be done.

In a further embodiment, the monitoring means are mobile meaning that they can move to one or more monitoring positions. In a preferred embodiment, the monitoring means are located inside the tower or the nacelle so that they are protected from environmental influences. In order to monitor the blade surface condition the monitoring means can move out of their inside position to one or more outside positions from which monitoring of the blade can take place.

In a further preferred embodiment, the wind turbine comprises moving means for moving the monitoring means. For this purpose, the monitoring means are mounted on the moving means. In a preferable embodiment, the moving means extend along the length of the tower and/or around the tower. The monitoring means are mounted on the moving means, preferably mounted in such a way that the moving means face the blades. Preferably, the monitoring means are mounted on the moving means in a swivel-mounted or rotatable way. Moving means can comprise at least one rail comprising a motor and a carriage which can move the monitoring means along the rail. In the case of a rail, it is advantageous that the rail is not positioned on the tower at the height of the tips of the blades. In strong wind conditions, the blade could bend and touch the tower and therefore damage the monitoring means. The moving means can also comprise a cable arrangement with which the monitoring means can be moved by pulling cables accordingly. In another alternative embodiment, the moving means can comprise at least one arm, on which at least one monitoring means are arranged. Preferably, the arm is extendible and can move the mounted monitoring means to any desired position. In yet another embodiment of the invention, the moving means is a movable ring which can move along the tower and around the tower.

The movement of the monitoring means, in particular the position and the orientation, can preferably be controlled remotely. The moving means are preferably mounted on the nacelle and/or the tower of the wind turbine, in particular at the outside of the nacelle and/or tower. In a further embodiment, the moving means are arranged in such a way that the monitoring means can rotate around the longitudinal axis of the tower by means of the moving means. In another embodiment, one end of the moving means is located inside the tower or the nacelle, while the rest of the moving means extends to the outside. In this case, the monitoring means can be moved from a shielded inside resting position to one or more outside monitoring positions by means of the moving means.

In a further aspect of the invention, the wind turbine blade comprises a blade pitch control, preferably a pitch bearing, for each blade which can rotate the blade around its longitudinal axis. Preferably, the blade which is to be monitored is aligned along the longitudinal direction of the tower by rotation of the hub. By rotating the blade around its longitudinal axis by means of the pitch control, not only the substantially one entire side of the blade can be monitored from its tip to its root end, but all sides of the blade are exposed to the monitoring means during a 360 degree rotation of the blade so that substantially the entire blade surface along its complete length can be monitored. Preferably, at least 80 percent, in particular at least 90 percent of the entire blade surface can be monitored. In this context, “circumferential direction” means the direction of rotation around the longitudinal axis of the blade. Preferably, not only substantially the entire blade surface but the entire surface condition can be monitored.

The invention also relates to a condition monitoring system (CMS) for monitoring the surface condition of a wind turbine blade of a wind turbine. A condition monitoring system is a predictive maintenance system which monitors a parameter of condition in order to indicate a significant change before a failure of a component occurs. According to the invention, the wind turbine comprises a tower, a nacelle and at least one blade which is to be monitored by monitoring means, said blade comprising a tip end and a root end. The monitoring means are adapted to monitor the surface condition of at least substantially one entire side of the blade from its tip end to its root end. The CMS is adapted to process the monitoring data from the monitoring means in order to assess the surface condition of the blade of a wind turbine. Monitoring means can preferably be optical recording means, such as photo or video cameras or means for transmitting and receiving acoustic waves, such as an acoustic sensor preferably for ultrasound. In a further embodiment of the invention, the monitoring means comprise at least one camera and/or at least one acoustic sensor. Monitoring data is the data recorded by the monitoring means and transmitted to the CMS and can comprise images, videos, acoustic waves or any other kind of data which can be recorded by the monitoring means.

Preferably, the condition monitoring system is adapted to process images of substantially the entire blade surface from various directions. Those various directions are based on the positions of the either fixedly or movingly installed monitoring means. In another preferred embodiment, the monitoring means comprise an array of microphones and the condition monitoring system is adapted to process data from an array of the microphones to detect the level, the type and/or the occurring place of noise generated by the wind turbine during its operation.

In a preferred embodiment, the CMS compares the received and/or processed data of the monitoring means with reference data. Reference data can be any previously set values or stored past monitoring data. By comparison of the data the CMS identifies surface changes of the blade, such as damages as well as their extent and their position. In an alternative embodiment, a remote user can evaluate the monitoring data. For this purpose, the monitoring data is preferably sent to a monitoring station. In a further preferable embodiment, the monitoring can be carried out in real time.

In another aspect of the invention, a method for monitoring the surface condition of at least substantially one entire side of a blade of a wind turbine is provided. In a first step, the surface condition of substantially one entire side is monitored by monitoring means. The monitoring data is transmitted to a condition monitoring system which then processes the data in order to identify any condition changes of the blade surface. The data transmission can be done by cable or wireless.

Preferably, the monitoring means move by means of moving means along the longitudinal direction of the tower to monitor the surface condition of at least substantially one entire side of the blade from its tip to its root end after aligning the blade along the longitudinal direction of the tower. Before moving the monitoring means along the longitudinal direction of the tower, the monitoring means can preferably be moved around the tower along its circumferential direction in order to position the monitoring means in accordance with the position of the nacelle and therefore the position of the blade.

In a further embodiment, the at least one blade is rotated by means of a pitch control system around its longitudinal axis. In this way, the blade surface condition along the circumferential direction of the blade along the substantially its complete length, therefore the condition of substantially the entire blade surface, can be monitored.

In a further preferred embodiment the monitoring means is connected to a lightning detection system. Consequently, the monitoring system can monitor the blade surface condition right after a stroke of lightning into the blade.

### BRIEF DESCRIPTION OF DRAWINGS

The invention will be described below with reference to the following figures which show in schematic representation

FIG. 1 is a front view of a wind turbine;

FIG. 2 is a front view of a wind turbine with a plurality of monitoring means;

FIG. 3 is a side view of the wind turbine of FIG. 2;

FIG. 4 is a front view of a wind turbine with monitoring means mounted on a rail;

FIG. 5 is a side view of the wind turbine of FIG. 4;

FIG. 6 is a front view of a wind turbine with monitoring means mounted on a movable ring;

FIG. 7 is a side view of the wind turbine of FIG. 6;

FIG. 8 is a front view of a wind turbine with monitoring means mounted on an extendible arm; and

FIG. 9 is a side view of the wind turbine of FIG. 8.

### DESCRIPTION OF EMBODIMENTS

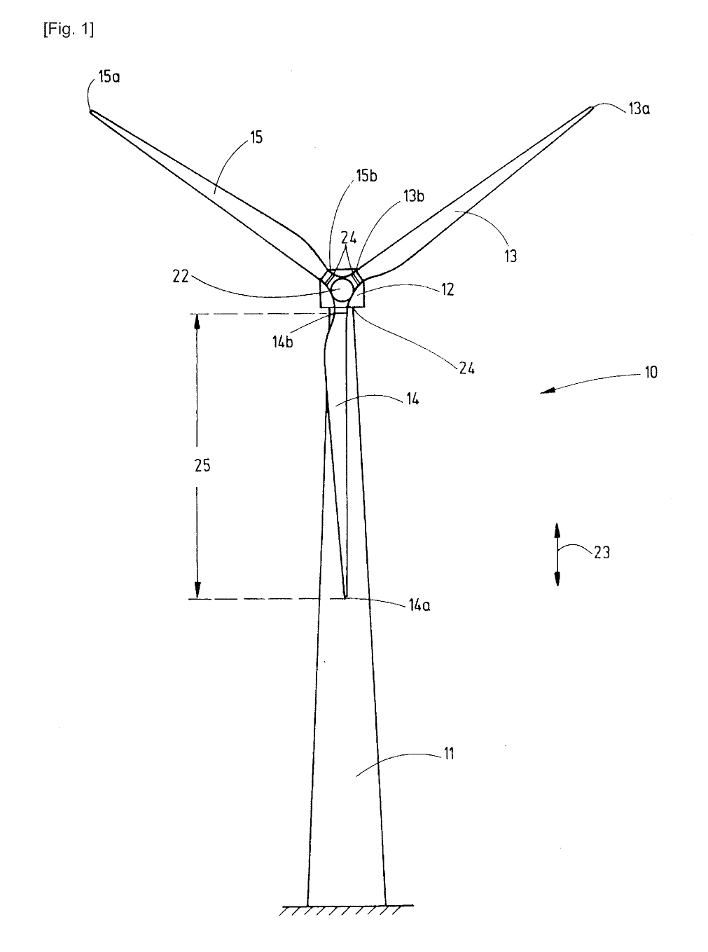

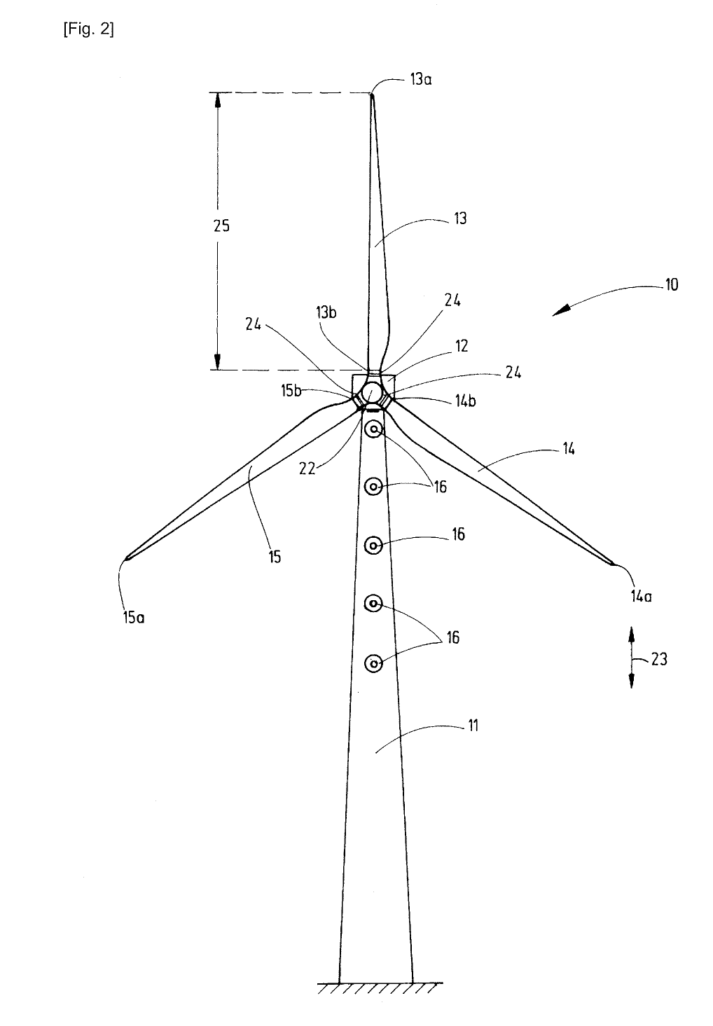

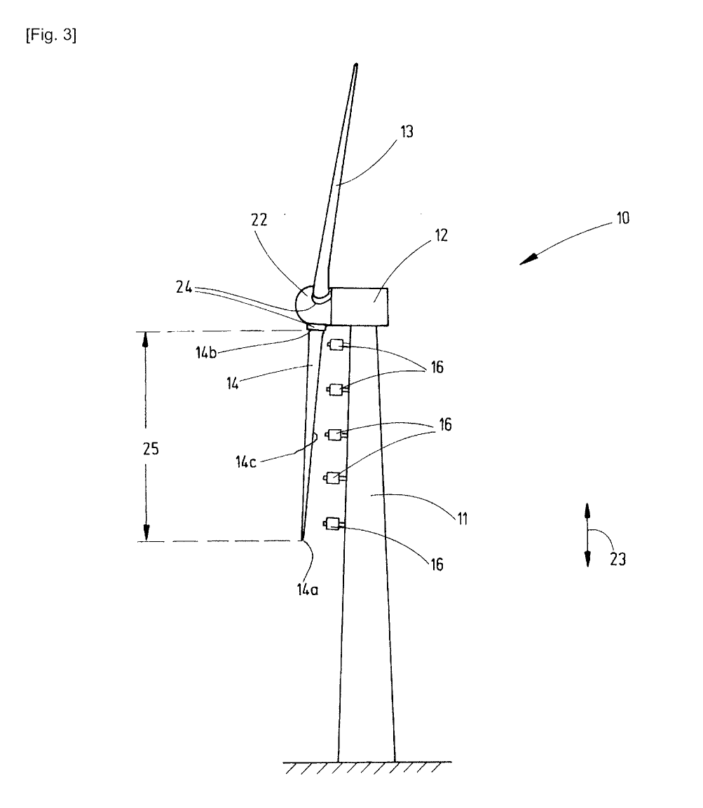

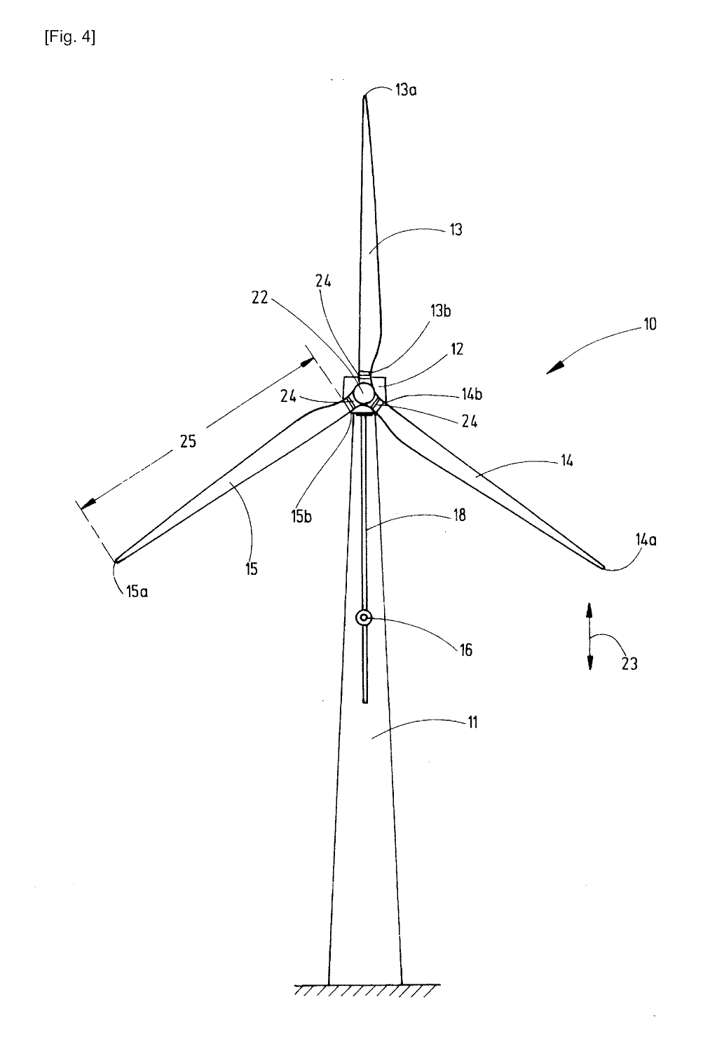

FIG. 1 shows a front view of a wind turbine 10 comprising a vertical tower 11, a nacelle 12 rotatably mounted atop of the tower 11 and three wind turbine blades 13, 14, 15. The wind turbine blades 13, 14, 15 comprise a tip end 13a, 14a, 15a and a root end 13b, 14b, 15b respectively, defining a length 25 of the equally sized blades 13, 14, 15. The wind turbine blades 13, 14, 15 are mounted to a hub 22 via pitch bearings 24 respectively, said pitch bearings 24 allow for the rotation of the blades 13, 14, 15 around their longitudinal axis. The hub 22 is rotatably arranged at the nacelle 12. In FIG. 1 a possible monitoring position of the surface condition of the blade 14 is shown. For this purpose, the hub 22 is arranged in such a rotational position that the blade 14 is aligned substantially parallel to the longitudinal direction 23 of the tower 11. Furthermore, the nacelle 12 is rotated around the longitudinal axis of the tower 11 in such a way that the tower facing side 14c (see FIGS. 3, 5, 7 and 9) of blade 14 faces monitoring means (see cameras 16 and acoustic sensor 17 in FIGS. 2 to 9). In this position, the surface condition of the tower facing side 14c of blade 14 from its tip end 14a to its root end 14b can be monitored by monitoring means which are either arranged along the tower 11 (see FIGS. 2 and 3) or can move along at least the longitudinal direction 23 of the tower 11 (see FIGS. 4 to 9).

In FIG. 2, a front view of a wind turbine 10 is shown which comprises a tower 11, a nacelle 12, three pitch bearings 24 and three wind turbine blades 13, 14, 15, said wind turbine blades 13, 14, 15 having a tip end 13a, 14a, 15a and a root end 13b, 14b, 15b respectively. Along the upper half of the length of the tower 11, which corresponds approximately to the length 25 of a wind turbine blade 13, 14, 15, five monitoring means in form of cameras 16 are arranged at equal distances in such a way that the entire tower facing side 14c of blade 14 can be covered by the recording range of the cameras 16. The cameras 16 are arranged in an approximately straight line, said line being substantially parallel to the longitudinal direction 23 of the tower 11.

FIG. 3 shows a side view of the wind turbine 10 of FIG. 2. The blade 14 is arranged substantially parallel to the longitudinal direction 23 of the tower 11 so that the side 14c of blade 14 faces the tower. In addition, the nacelle 12 is rotated in such a position that the tower facing side 14c faces the cameras 16. By means of the arrangement of the multiple cameras 16 along the tower 11, the tower facing side 14c of blade 14 can be monitored from the tip end 14a to the root end 14b of the blade 14. Therefore, the surface condition of substantially one entire side 14c of the blade 14 can be monitored along the complete length 25 of the blade 14. Since the blade 14 is mounted to the hub 22 via a pitch bearing 24, the blade 14 can be rotated around its longitudinal axis so that every side of the blade 14 can face the tower 11 and thus the cameras 16. As a consequence, each side of the blade 14 can be monitored.

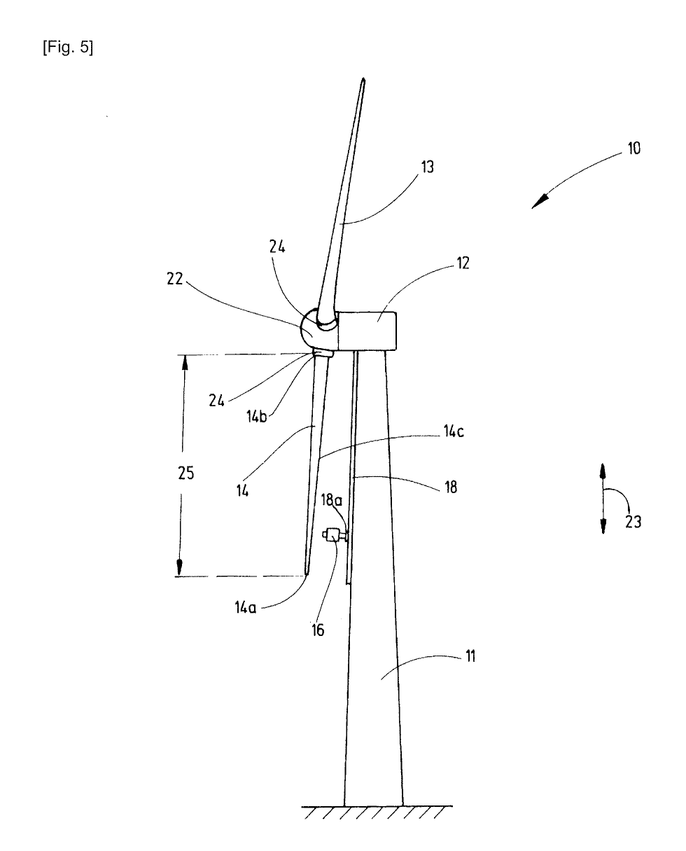

FIG. 4 shows a front view of a wind turbine 10 with monitoring means and moving means of another embodiment of the present invention. The monitoring means is a camera 16 which is mounted on moving means. The moving means is a rail 18 which is mounted on the tower 11 and extends along its longitudinal direction 23 in an approximately straight line. The rail 18 extends from the upper end of the tower along a length which approximately corresponds to the length 25 of a wind turbine blade down towards the lower end of the tower. The rail 18 comprises a motor and a carriage 18a to which the camera 16 is mounted. By means of the motor and the carriage 18a (see FIG. 5) the camera 16 can be moved along the rail 18. The camera 16 can move along the rail 18 in such a way that an entire tower facing side 14c (see FIG. 5) of a blade 14 from its tip end 14a to its root end 14b can be monitored by means of just one camera 16, once the blade 14 is arranged substantially parallel to the longitudinal direction 23 of the tower 11 and one side 14c of the blade 14 faces the tower 11.

In FIG. 5 a side view of the wind turbine 10 of FIG. 4 is shown. The hub 22 and the nacelle 12 are arranged in such rotational positions that the blade 14 is arranged substantially parallel to the longitudinal direction 23 of the tower 11 so that the tower facing side 14c of blade 14 faces the rail 18. The tower facing side 14c of blade 14 can be monitored by means of moving the camera 16 along the rail 18 from the tip end 14a to the root end 14b of the blade 14. The pitch bearing 24 on which the blade 14 is mounted allows the rotation of the blade 14 so that every side of the blade 14 can face the tower 11 and thus be monitored by the camera 16.

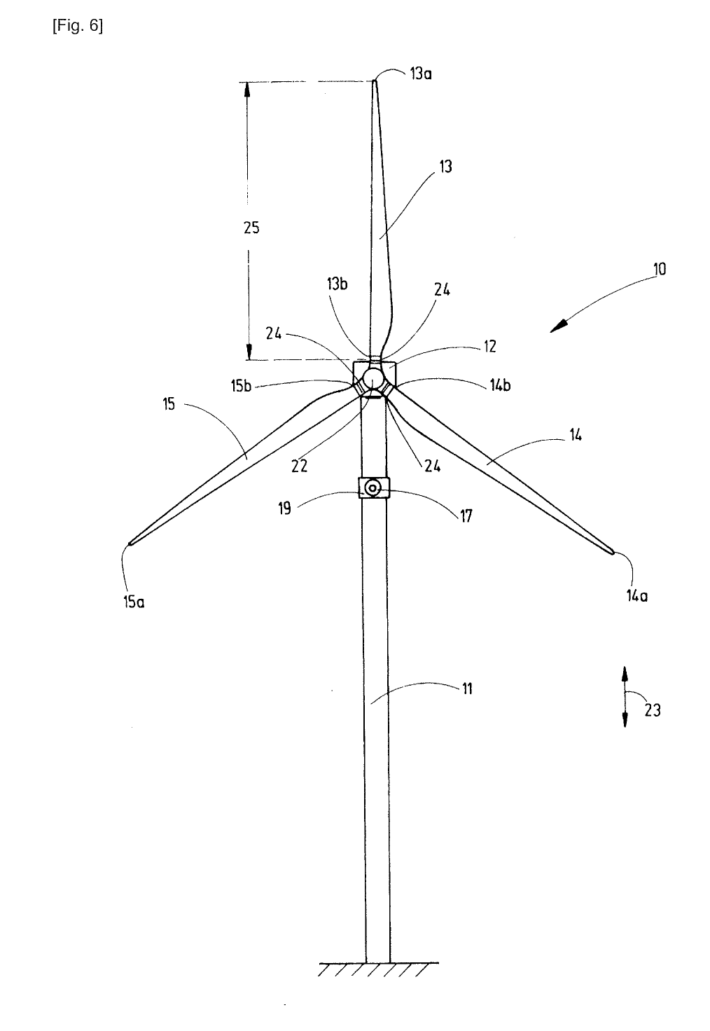

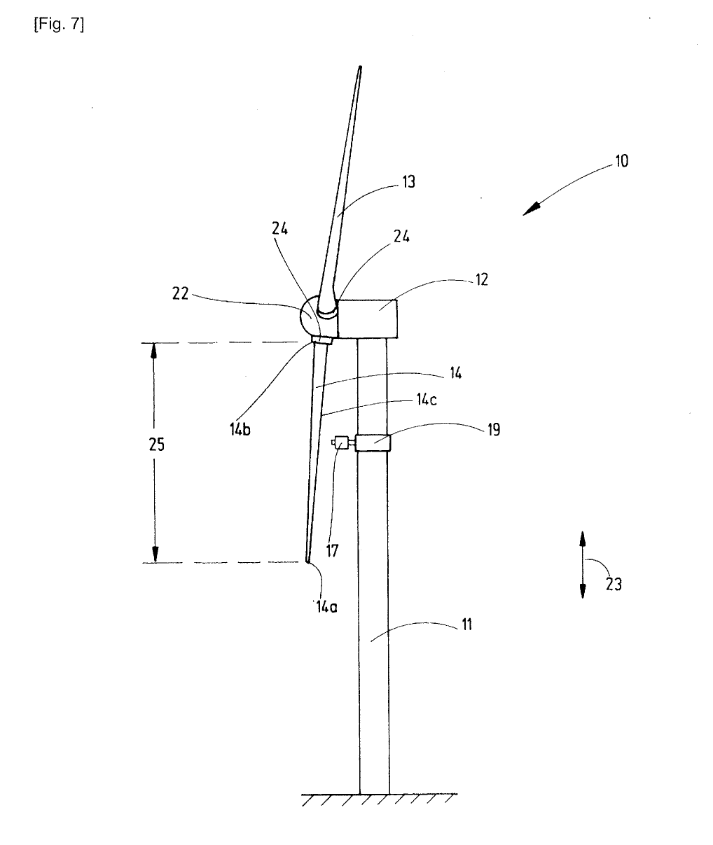

FIG. 6 shows a front view of a wind turbine 10 with monitoring means and moving means of yet another embodiment of the present invention. The blades 13, 14, 15 are mounted to the hub 22 via pitch bearings 24. The monitoring means is an acoustic sensor 17 for ultrasound which comprises a receiver and a transmitter for ultrasound. The acoustic sensor 17 is mounted on a movable ring 19 functioning as moving means. The movable ring 19 can move along the longitudinal direction 23 of the tower 11 and around the tower 11 by means of a suitable drive. Once a blade 14 is arranged substantially parallel to the longitudinal direction 23 of the tower 11, the acoustic sensor 17 emits ultrasound onto the surface of the tower facing side 14c (see FIG. 7) of the blade 14. The return sound waves of the excited oscillations in the blade material are again received by the acoustic sensor 17. Since the ring 19 can also move around the tower 11, the acoustic sensor 17 can be moved along the circumferential direction 23 of the tower 11. Due to this, the acoustic sensor 17 can be positioned in such a way that it faces the tower facing side 14c of the blade 14 (see FIG. 7). Without the possibility of moving the monitoring means around the tower, the nacelle 12 would have to be rotated so that one side of the blade to be monitored faces the acoustic sensor 17.

FIG. 7 is a side view of the wind turbine 10 of FIG. 6. The tower facing side 14c of blade 14 can be monitored by means of moving the acoustic sensor 17 along the tower 11 by means of the ring 19 from the tip end 14a to the root end 14b of the blade 14. By means of the pitch bearing 24, the blade 14 can be rotated around its longitudinal axis. Due to the rotation of the blade 14, each side of the blade 14 can be arranged such that it faces the tower 11 and therefore faces the acoustic sensor 17. As a result, each side of the blade 14 from the tip end 14a to the root end 14b of the blade 14, i.e. the entire blade surface, can be monitored by means of the acoustic sensor 17.

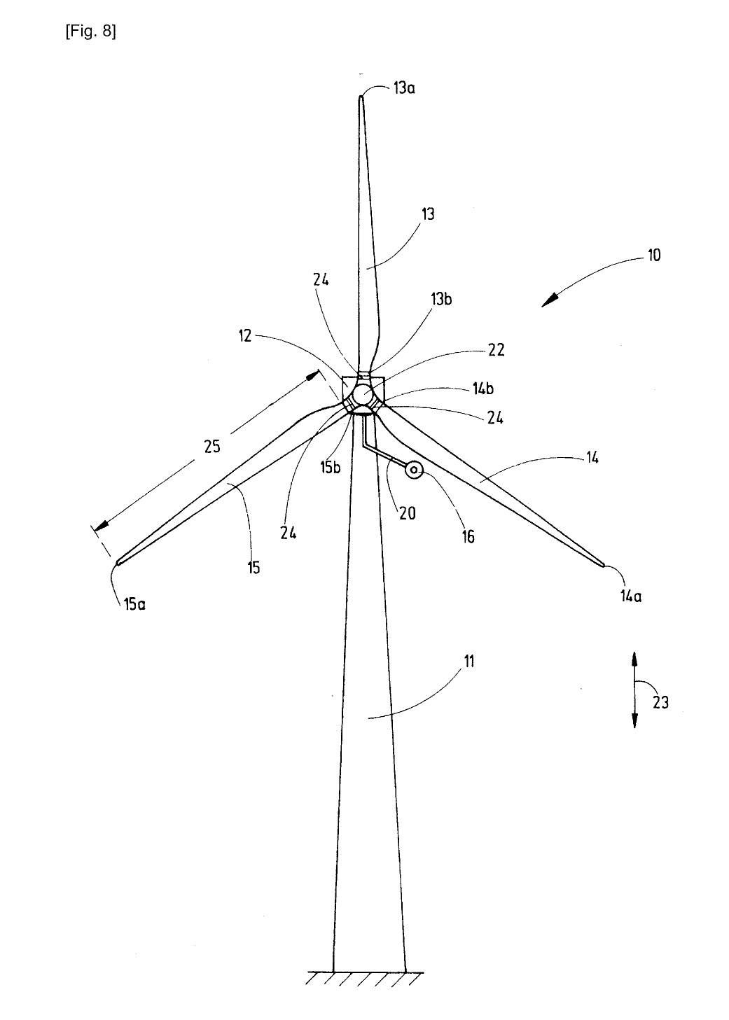

In FIG. 8 a front view of a wind turbine 10 with monitoring means and moving means of yet another embodiment of the present invention is shown. A monitoring means in form of a camera 16 can be moved by means of an extendable arm 20 from a resting position inside the nacelle 12 to monitoring positions outside of the nacelle 12. For this purpose, the camera 16 is arranged at the free end of the extendible arm 20. The extendible arm is arranged at the nacelle in a swivel-mounted way. In addition, the extendible arm comprises a further swivel bearing along its length so that a further range for monitoring can be achieved. In order to monitor the surface condition of a blade 13, 14, 15 the extendible arm 20 moves the camera 16 along the length 25 of the blade 13, 14, 15 from its root end 13b, 14b, 15b to its tip end 13a, 14a, 15a so that an entire side of the blade along the length 25 of the blade can be monitored. Since the extendible arm 20 can move freely and is not restricted to only a movement along the longitudinal direction 23 of the tower 11, the blade 13, 14, 15 can be monitored without the need to position it according to the longitudinal direction 23 of the tower 11.

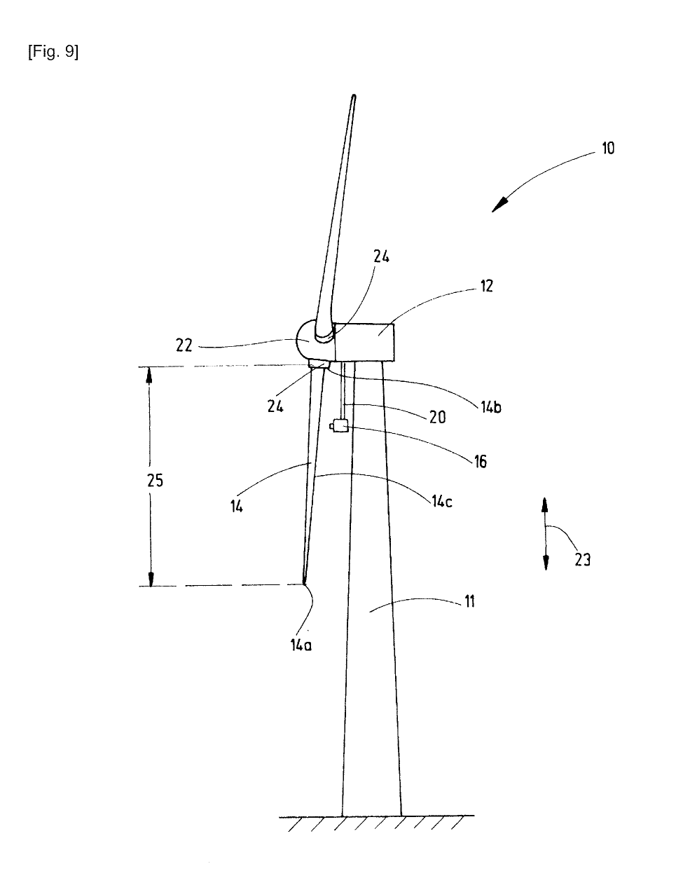

FIG. 9 shows a side view of the wind turbine 10 of FIG. 8. By means of the extendible arm 20, the entire side 14c of the blade 14 can be monitored along its entire length 25 from the tip end 14a to the root end 14b of the blade 14. As the blade 14 is mounted to the hub 22 via a pitch bearing 24, the blade 14 can be pitched around its longitudinal axis in such a way that every side of the blade 14 can face the tower 11 and thus the cameras 16. Consequently, each side of the blade 14 can be monitored from its tip end 14a to its root end 14b so that the entire blade surface can be monitored.

1. A wind turbine, comprising:
a tower,
a nacelle,
at least one blade with a tip end and a root end, and monitoring means for monitoring the surface condition of the blade,
wherein said monitoring means are located at the tower or at the nacelle, and
wherein said monitoring means are adapted to monitor the surface condition of at least substantially one entire side of the blade from its tip end to its root end.

2. The wind turbine according to claim 1,
wherein the monitoring means comprise optical recording means or means for transmitting and receiving acoustic waves.

3. The wind turbine according to claim 1,
wherein the monitoring means are mounted on moving means,
said moving means being mounted on the tower or the nacelle.

4. The wind turbine according to claim 1,
wherein a plurality of monitoring means are arranged on the tower or the nacelle.

5. The wind turbine according to claim 2,
wherein the optical recording means comprise at least one wide-angle lens.

6. The wind turbine according to claim 2,
wherein the optical recording means comprise a water-proof housing or cleaning means for the optical recording means.

7. The wind turbine according to claim 1, comprising:
a blade pitch control for rotating the at least one blade around its longitudinal axis,
wherein the blade pitch control is adapted to rotate the at least one blade for monitoring substantially the entire blade surface condition in the circumferential direction of the blade.

8. A condition monitoring system for monitoring the surface condition of a wind turbine blade of a wind turbine,
said wind turbine comprising
a tower,
a nacelle,
at least one blade with a tip end and a root end, and monitoring means for monitoring the surface condition of the blade,
wherein said monitoring means are located at the tower or the nacelle, wherein said monitoring means are adapted to monitor the surface condition of at least substantially one entire side of the blade from its tip end to its root end, and
wherein the condition monitoring system is adapted to process monitoring data from the monitoring means.

9. The condition monitoring system according to claim 8,
wherein the condition monitoring system is adapted to process images of substantially the entire blade surface.

10. The condition monitoring system according to claim 8,
wherein the condition monitoring system is adapted to process images of substantially the entire blade surface from various directions based on the position of the monitoring means.

11. The condition monitoring means according to claim 8,
wherein the monitoring means comprise an array of microphones, and
wherein the condition monitoring system is adapted to process data from the array of the microphones to detect the level, the type and/or the occurring place of noise generated by the wind turbine.

12. The condition monitoring system according to claim 8,
wherein the condition monitoring system compares the processed monitoring data with reference data to identify changes of the blade surface condition.

13. A method for monitoring the surface condition of at least one blade of a wind turbine having a tower, comprising the steps of:
monitoring the surface condition of at least substantially one entire side of the blade from its tip end to its root end using monitoring means,
transmitting the monitoring data to a condition monitoring system, and
processing of the monitoring data by the condition monitoring system in order to identify blade surface condition changes.

14. The method according to claim 13, comprising the steps of:
aligning the blade along the longitudinal direction of the tower, and moving the monitoring means along the tower to monitor the blade surface condition of at least substantially one entire side of the blade from its tip end to its root end.

15. The method according to claim 14,
wherein the monitoring means is moved around the tower along its circumferential direction according to the position of the blade.

16. The method according to claim 13,
wherein the blade is rotated around its longitudinal axis by means of a pitch control system to monitor substantially the entire blade surface condition along the circumferential direction of the blade.
